(19) United States
(12) Patent Application Publication
(10) Pub. No.: US 2017/0132999 A1
(43) Pub. Date: May 11, 2017

(54) SOUND ATTENUATION

(71) Applicant: Carbon Air Limited, Salford, Greater Manchester (GB)

(72) Inventors: John FitzGerald Coakley, New Mills (GB); Rodolfo Gustavo Venegas, Villeurbanne (FR); Andrew Thomas Moorhouse, Withington (GB)

(21) Appl. No.: 15/319,787

(22) PCT Filed: Jun. 17, 2015
(86) PCT No.: PCT/GB2015/051779

§ 371 Date: Dec. 18, 2016

(30) Foreign Application Priority Data
Jun. 18, 2014 (GB) 1410856.7

(51) Int. Cl. G10K 11/172; G10K 11/168

(52) U.S. Cl. CPC G10K 11/172; G10K 11/168

(57) ABSTRACT

The present invention provides a sound attenuating apparatus including a substrate element comprising at least one first heterogeneous material, and at least one region comprising at least one further heterogeneous material at least partially located in the substrate element, wherein the at least one further heterogeneous material has at least one more scale of heterogeneity than the at least one first heterogeneous material. The present invention provides a method and apparatus for attenuating sound through a cavity construction in buildings and vehicles or the like, wherein the method comprises locating at least one region of adsorptive material in a cavity defined between a first wall region and a further wall region to attenuate sound transmission across the wall regions.

### FIELD OF THE INVENTION

The present invention relates to a method and apparatus for attenuating sound and in particular, but not exclusively, the present invention relates to a method, use and apparatus for attenuating sound through a cavity construction in buildings and vehicles or the like. The present invention also relates to the formation and use of a sound attenuating body for attenuating sound in buildings and vehicles or the like.

The building and automotive industries in particular are driving the development of new materials and technologies for attenuating sound (or more specifically ‘noise’ which can be defined as unwanted sound) more efficiently and particularly at low frequencies of less than 400 Hz. For example, sound attenuation is becoming increasingly important to reduce, or even eliminate, the amount of noise associated with the powertrain, rolling surfaces and air aerodynamic effects of a vehicle, and minimising the amount of such noise being transmitted through a bulkhead or floor, or the like, and entering a cabin of a vehicle for many quality and comfort purposes. The size of a sound attenuating structure in a vehicle for example is often dependent on the efficiency of the sound attenuating lining materials used in the structure, particularly at the lower frequencies of sound that require relatively large structures to achieve efficient sound attenuation.

Sound attenuation is also becoming increasingly important to reduce, or even eliminate, the amount of sound transmission through a wall or floor of a building, for example, and sound attenuating materials are typically located under floors and in cavity walls and ceiling voids in an attempt to reduce sound transmission throughout the building. Sound absorption at lower frequencies is also needed to attenuate reverberant noise in confined spaces, such as meeting rooms, where intelligibility is an issue. However, the building industry is strongly inclined to specify established materials with known properties wherever possible which are typically not wholly efficient sound absorbing materials.

The transmission of sound across a solid wall or a single skin partition is critically dependent on its mass per unit area and frequency. Most materials follow this theoretical ‘mass law’ in a given frequency range. This law indicates that the sound insulation performance of a solid element will increase by approximately 6 dB for every doubling of mass. However, if a single solid partition is divided into two or more partition leaves with the same mass overall, the transmission loss achieved is generally larger than that of the single partition. The two partition leaves are connected by a body of air within the cavity which behaves like a spring that ‘acoustically’ connect them and, like any spring and mass arrangement, the system will resonate at a particular frequency, which is normally called mass-air-mass resonant frequency. At this resonant frequency the two partition leaves will vibrate in unison and transmission loss will tend towards zero.

Conventional methods of increasing transmission loss of frequencies above resonance across a partition, such as a cavity wall, include increasing the size of the cavity between two partition leaves to decrease the stiffness of the air spring acoustically coupling the two partition leaves (and thus decrease the resonance frequency of the system), including conventional sound insulation material in the cavity to absorb sound entering the cavity, and/or adding mass to the system by including more layers to the partition leaves or by increasing the thickness of each partition leaf. However, an increase in size and/or weight is generally not desirable particularly in building and vehicle applications.

Furthermore, deep cavities are inefficient in terms of building or vehicle packaging and acoustic treatment is often required within existing standard panel gaps, particularly in the retrofit building market and in the conversion of buildings from single to multiple occupancy. Also, it is often not possible to alter ceiling, floor or party wall thicknesses to achieve the required acoustic transmission loss performance without extensive and expensive redevelopment of the entire building structure, with the introduction of expensive false ceilings and floating floors that restrict interior space. In automotive applications, floor, door and bulkhead structures are designed with structural performance in mind and mass is kept to a strict minimum. Acoustic engineers are thus expected to maximise transmission loss performance without the addition of panel gap distance or weight.

Heterogeneous materials, such as cellular, fibrous, granular or porous materials are conventionally used to attenuate sound in view of their sound absorptive and sound insulating properties. Despite the differences in morphology of these types of material, they all include a skeletal portion, often referred to as a ‘solid frame’, and many voids (pores) at a microscopic scale which are typically saturated with a fluid and form a fluid network which may be connected or unconnected. These types of materials can be defined as 2-scale or single porosity materials, i.e. having macroscopic and microscopic scales and a single fluid network at a microscopic scale. Sound attenuation in heterogeneous 2-scale materials is mainly determined by two mechanisms of energy dissipation; namely viscous and thermal dissipation.

However, the effectiveness of a 2-scale material for absorbing lower frequency sound is poor. Increasing the thickness of the material can improve the low frequency sound absorption of the material but the material would generally have to be impracticably thick to efficiently absorb low frequency sound.

Placing a 2-scale material layer at a certain distance from a rigid surface, such as a wall, may also improve sound absorption. However, since the sound absorption effectiveness of 2-scale materials is mainly due to viscous dissipation, which in turn relates to the particle velocity of the saturating fluid of the material, it is desirable to place the material where the particle velocity is at a maximum which is at a quarter wavelength of the lowest frequency of interest. Therefore, to effectively absorb sound waves having a wavelength of about around 172 cm and a frequency of 200 Hz, for example, the gap between the material and the rigid surface would need to be about around 43 cm which again is impractical.

3-scale materials have a further scale of porosity and in turn an additional fluid network at a mesoscopic level. Thus, 3-scale materials, or so-called ‘double porosity’ materials, have fluid networks at mesoscopic and microscopic levels. 3-scale materials, such as expanded perlite, vermiculite, zeolites or the like, have been found to achieve higher levels of low frequency sound absorption in view of the different attenuating mechanisms not found in single porosity materials. Where the characteristic size of the material at mesoscopic and microscopic is substantially similar, e.g. one is about around ten times larger than the other, the dissipation of sound energy is caused by viscous and thermal dissipation at both the mesoscopic and microscopic scales, i.e. four mechanisms of energy dissipation exist. Where the characteristic size of the material at mesoscopic and microscopic is substantially different, e.g. one is about around a thousand times larger than the other, the dissipation of sound energy is caused by viscous and thermal dissipation at both the mesoscopic and microscopic scales, but also by pressure diffusion from the mesoscopic scale to the microscopic scale, i.e. five mechanisms of energy dissipation exist. However, although a layer of 3-scale material can improve sound absorption at low frequencies, the improvement is only evident at the higher end of the low frequency sound range. Furthermore, 3-scale materials do not achieve efficient sound absorption at high frequencies compared with a highly porous fibrous or foam material for example.

4-scale or ‘triple porosity’ materials, such as activated carbon, activated alumina, or the like, also exist. Activated carbon in particular has excellent low frequency sound attenuation characteristics. The main mechanisms of sound energy dissipation in activated carbon are viscous and thermal dissipation at the mesoscopic, microscopic and nanoscopic scales, pressure dissipation from the mesoscopic scale to the microscopic scale, and sorption processes predominantly at the nanoscopic scale. As for 3-scale materials, activated carbon is available in powder, granular, pellet and monolithic form and the same lack of efficient high-frequency sound absorption is observed.

Furthermore, affordable 3- and 4-scale materials are typically available in granular form and a binder is typically required to agglomerate the grains into a useful and practical sound attenuating material. However, the voids between the grains that make up an important scale of porosity that should otherwise be preserved for efficient sound attenuation, become blocked by the binder. Additionally, such materials are also heavier and more expensive than conventional 2-scale acoustic materials which in turn makes them less desirable for efficient sound attenuation purposes.

### SUMMARY OF THE INVENTION

It is an aim of the present invention to at least partly mitigate the above-mentioned problems.

It is an aim of certain embodiments of the present invention to provide apparatus that increases the number of scales of heterogeneities of a first heterogeneous material to augment its sound attenuating performance via the addition of at least one region of at least one further heterogeneous material that has a greater number of scales of heterogeneities.

It is an aim of certain embodiments of the present invention to provide apparatus that increases the sound attenuating performance of sound attenuating materials that are already established and well understood in, for example, the building and vehicle trim industries, whilst ensuring weight, size and/or cost of the resultant high performance composite is minimised.

It is an aim of certain embodiments of the present invention to introduce at least one extra scale of heterogeneity into a sound attenuating body to improve the overall sound attenuating characteristic of that body.

It is an aim of certain embodiments of the present invention to provide a method and apparatus whereby a substrate having certain sound attenuating characteristics is provided with one or more regions of another material to provide an overall improved ability to attenuate sound.

It is an aim of certain embodiments of the present invention to provide a convenient and inexpensive method of manufacturing a sound attenuating body that augments the underlying sound attenuating capacity of the principal component of that body.

It is an aim of certain embodiments of the present invention to provide apparatus that increases the sound attenuating performance of sound attenuating materials that are already established and well understood in, for example, the building and vehicle trim industries.

It is an aim of certain embodiments of the present invention to increase sound transmission loss across a mass-fluid-mass system, such as a double partition cavity wall, particularly at low frequencies.

It is an aim of certain embodiments of the present invention to provide a method and apparatus for attenuating noise, particularly at low frequencies, across a cavity construction, i.e. from one side through to an opposite side, including two spaced apart wall members, e.g. partition leaves, and a cavity defined there between.

It is an aim of certain embodiments of the present invention to provide a method of increasing sound transmission loss through an existing cavity construction in a building or vehicle without having to increase the dimensions of the cavity construction itself.

It is an aim of certain embodiments of the present invention to decrease the resonant frequency of a mass-fluid-mass system, such as a double partition cavity wall, by locating a region of adsorptive material in the cavity between partition leaves to thereby increase the transmission loss of all frequencies at and above the shifted resonant frequency.

It is an aim of certain embodiments of the present invention to increase the sound transmission loss performance, particularly at and around the shifted resonance frequency, of a cavity construction in a building or vehicle by locating a region of adsorptive material in the cavity between partition leaves of the cavity construction.

According to a first aspect of the present invention there is provided apparatus for attenuating sound, comprising:
at least one substrate element comprising at least one first heterogeneous material; and
at least one region comprising at least one further heterogeneous material at least partially located in the substrate element; wherein
said at least one further heterogeneous material has at least one more scale of heterogeneity than the at least one first heterogeneous material.

Aptly, the at least one region comprises a plurality of spaced apart regions.

Aptly, the at least one further heterogeneous material comprises at least one multi-scale heterogeneous material.

Aptly, the at least one first heterogeneous material comprises a 2-scale heterogeneous material and the at least one further heterogeneous material comprises at least one 3-scale heterogeneous material and/or or at least one 4-scale heterogeneous material.

Aptly, the at least one further heterogeneous material comprises at least one sorptive material.

Aptly, the at least one further heterogeneous material comprises an adsorptive material.

Aptly, the at least one region comprises a granular material enclosed in a membrane.

Aptly, the membrane comprises a 2-scale fibrous, porous or cellular material.

Aptly, the membrane is substantially acoustically transparent and/or substantially permeable to sound for sound absorption.

Aptly, the membrane is acoustically transparent and/or impermeable to sound for sound insulation.

Aptly, the at least one region of further heterogeneous material comprises a unitary element of the further heterogeneous material.

Aptly, the at least one unitary element comprises a self-supported monolith of the further heterogeneous material.

Aptly, the at least one further heterogeneous material comprises activated carbon.

Aptly, the at least one first heterogeneous material comprises a 2-scale fibrous or cellular material.

Aptly, the at least one first heterogeneous material comprises glass wool, rock wool, mineral wool, slag wool, glass fibre or foam.

Aptly, the at least one first heterogeneous material comprises perlite. Aptly, the at least one first heterogeneous material comprises expanded perlite.

Aptly, the at least one substrate comprises at least one compartment in which the at least one region of further heterogeneous material is at least partially located.

Aptly, the at least one compartment is located between outer surfaces of the substrate.

Aptly, the at least one compartment is located proximal to an outer surface of the substrate.

Aptly, the at least one compartment comprises at least one recess extending inwardly from an outer surface of the substrate.

Aptly, the outer surface is a sound receiving surface of the substrate.

Aptly, the at least one region of at least one further heterogeneous material has a shape that is complementary to a shape of the at least one recess.

Aptly, an opening of the at least one recess at the outer surface is shaped to receive the at least one region of further heterogeneous material.

Aptly, a plurality of compartments each containing at least one respective region of the at least one further heterogeneous material are arranged in a predetermined pattern in the substrate.

Aptly, the at least one compartment has a depth of up to about around 95% of a thickness of the substrate.

Aptly, the at least one compartment has a depth of about around 10% of the thickness of the substrate.

Aptly, each compartment is spaced apart from an adjacent compartment by a separation distance of about around three times greater than a characteristic size of the at least one further heterogeneous material.

Aptly, the separation distance is about around 1-2 cm. Aptly, the separation distance is less than 1 cm.

Aptly, the at least one substrate is substantially sheet-like.

Aptly, the at least one region of the at least one further heterogeneous material is located between the substrate and a closure layer that extends over an outer surface of the substrate.

Aptly, the at least one region of at least one further heterogeneous material is secured to the closure layer.

Aptly, the closure layer is substantially sound permeable.

Aptly, the closure layer comprises at least one layer having a flow resistance of less than about around 300 kg/s/m.

Aptly, the closure layer comprises a 2-scale heterogeneous material.

Aptly, the closure layer comprises at least one layer of a sound permeable woven or non-woven membrane or fine gauze material.

Aptly, the closure layer has a thickness of about around 20 to 15000 μm. Aptly, the closure layer has a thickness of about around 20 to 1000 μm.

Aptly, the closure layer has a thickness of about around 0.5 to 10 mm.

According to a second aspect of the present invention there is provided a building comprising the apparatus according to the first aspect of the present invention.

According to a third aspect of the present invention there is provided a vehicle comprising the apparatus according to the first aspect of the present invention.

According to a fourth aspect of the present invention there is provided a use of the apparatus according to the first aspect of the present invention.

Aptly, the sound comprises sound waves having a frequency of about around 0.001-20 kHz.

Aptly, the sound comprises sound waves having a frequency of about around 20 Hz-400 Hz.

According to a fifth aspect of the present invention there is provided a method of manufacturing a sound attenuating body, comprising:
providing at least one substrate element comprising at least one first heterogeneous material; and
at least partially locating at least one region comprising at least one further heterogeneous material in the substrate element;
wherein said at least one further heterogeneous material has at least one more scale of heterogeneity than the at least one first heterogeneous material.

Aptly, the method further comprises:
locating the at least one region in at least one compartment in the substrate element.

Aptly, the method further comprises:
enclosing the at least one region in a substantially acoustically permeable membrane, wherein the at least one further heterogeneous material is in granular or powder form.

Aptly, the method further comprises:
locating the at least one region between the at least one substrate element and a closure layer that extends over an outer surface of the at least one substrate element.

Aptly, the method further comprises:
binding the closure layer to the outer surface of the at least one substrate element.

According to a sixth aspect of the present invention there is provided a method of improving sound attenuation at a location in a building or vehicle, comprising:
locating a sound attenuating body at a location in a building or vehicle, said body comprising at least one substrate element and at least one region at least partially located in the substrate element, wherein the at least one substrate element comprises at least one first heterogeneous material and the at least one region comprises at least one further heterogeneous material having at least one more scale of heterogeneity than the at least one first heterogeneous material.

According to a seventh aspect of the present invention there is provided apparatus for attenuating sound, comprising:
at least one substrate element comprising a first heterogeneous material; and
at least one region comprising a further heterogeneous material at least partially located in the substrate element; wherein
said further heterogeneous material has at least one scale of heterogeneity not provided by the first heterogeneous material of the substrate element.

Aptly, the further material is located in the material to increase an effectiveness of the substrate element for attenuating sound.

According to an eighth aspect of the present invention there is provided apparatus for attenuating sound, comprising:
at least one region comprising at least one first heterogeneous material having N scales of heterogeneity and at least partially located in at least one substrate element comprising a further heterogeneous material having M scales of heterogeneity; wherein N>M and N and M are both non zero integers.

According to a ninth aspect of the present invention there is provided apparatus for attenuating sound, comprising:
at least one region comprising at least one first heterogeneous material having a first number of scales of heterogeneity and at least partially located in at least one substrate comprising at least one further heterogeneous material having a further number of scales of heterogeneity, wherein said first number of scale of heterogeneity is greater than said further number of scales of heterogeneity to increase an effective number of scales of heterogeneity of the substrate for attenuating sound.

According to a tenth aspect of the present invention there is provided a method of manufacturing a sound attenuating body, comprising:
at least partially locating at least one region comprising at least one first heterogeneous material having a first number of scales of heterogeneity in at least one substrate comprising at least one further heterogeneous material having a further number of scales of heterogeneity, wherein said first number of scales of heterogeneity is greater than said further number of scales of heterogeneity to increase an effective number of scales of heterogeneity of the at least one substrate for attenuating sound.

According to an eleventh aspect of the present invention there is provided apparatus for attenuating sound transmission, comprising:
a first wall region having an outwardly facing surface configured to receive incident sound waves;
a further wall region spaced apart from the first wall member to define a cavity between the wall regions; and
at least one region of sorptive material located in the cavity to attenuate sound transmission across the wall regions in respect of the incident sound waves.

Aptly, at least the wall regions and the cavity define a resonant system and at least a first resonant frequency of the resonant system is substantially decreased responsive to the at least one region of sorptive material located in the cavity.

Aptly, wherein the first resonant frequency is decreased to about around 20-400 Hz responsive to the at least one region of sorptive material located in the cavity.

Aptly, the sound transmission loss across the wall regions is substantially increased in respect of incident sound wave frequencies at and around the decreased resonant frequency.

Aptly, the sound transmission loss across the wall regions is substantially increased in respect incident sound wave frequencies that are above the decreased resonant frequency.

Aptly, the sound transmission loss at the decreased resonant frequency is increased to about around 1-20 dB responsive to the at least one region of sorptive material located in the cavity.

Aptly, the at least one region of sorptive material is in powder or granular form and is enclosed in a membrane.

Aptly, the membrane is acoustically transparent.

Aptly, the at least one region of sorptive material comprises a monolithic element of sorptive material.

Aptly, the at least one region of sorptive material is at least partially located in a substantially porous substrate element.

Aptly, the substrate element comprises a 2-scale fibrous or cellular material.

Aptly, the substrate element comprises at least one compartment in which the at least one region of sorptive material is at least partially located.

Aptly, the at least one region of sorptive material is located between the substrate element and a closure layer that extends over an outer surface of the substrate element.

Aptly, the closure layer extends beyond an edge of the substrate element.

Aptly, the at least one region of sorptive material is spaced apart from the first and further wall regions.

Aptly, the first wall region is substantially parallel with the further wall region.

According to a twelfth aspect of the present invention there is provided a building comprising apparatus according to the first or tenth aspect of the present invention.

According to a thirteenth aspect of the present invention there is provided a vehicle comprising apparatus according to the first or tenth aspect of the present invention.

According to a fourteenth aspect of the present invention there is provided use of apparatus according to the first or tenth aspect of the present invention for attenuating sound.

Aptly, the sound comprises sound waves having a frequency of about around 0.001-20 kHz.

Aptly, the sound comprises sound waves having a frequency of about around 20 Hz-400 Hz.

According to a fifteenth aspect of the present invention there is provided use of at least one region of sorptive material located in a cavity defined between a first wall region spaced apart from a further wall region to attenuate sound transmission across the wall regions in respect of sound waves incident on an outwardly facing surface of the first wall region.

According to a sixteenth aspect of the present invention there is provided a method of manufacturing apparatus for attenuating sound transmission, comprising:
locating at least one region of sorptive material in a cavity defined between a first wall region and a further wall region to attenuate sound transmission across the wall members in respect of sound waves incident on an outwardly facing surface of the first wall region.

Aptly, locating comprises:
at least partially filling the cavity with the sorptive material.

Aptly, locating comprises:
disposing the at least one region of sorptive material on an inwardly facing surface of at least one of the first and further wall regions.

Aptly, locating comprises:
disposing a substantially porous substrate element in the cavity wherein the at least one region of sorptive material is at least partially located in the substrate element.

According to a seventeenth aspect of the present invention there is provided a method of attenuating sound transmission, comprising:
locating at least one region of sorptive material in a cavity defined between a first wall region and a further wall region to attenuate sound transmission across the wall regions in respect of sound waves incident on an outwardly facing surface of the first wall region.

Aptly, the method further comprises decreasing at least a first resonant frequency of a resonant system comprising at least the wall regions and the cavity responsive to locating the at least one region of sorptive material in the cavity.

Aptly, the method further comprises increasing sound transmission loss across the wall regions in respect of incident sound wave frequencies that equal the decreased resonant frequency.

Aptly, the method further comprises increasing noise transmission loss across the wall regions in respect of incident sound wave frequencies that are larger than the decreased resonant frequency.

According to an eighteenth aspect of the present invention there is provided apparatus constructed and arranged substantially as hereinbefore described with reference to the accompanying drawings.

According to a nineteenth aspect of the present invention there is provided a method substantially as hereinbefore described with reference to the accompanying drawings.

Certain embodiments of the present invention may provide an apparatus comprising at least one region of at least one heterogeneous material that increases the effective number of scales of heterogeneity, or in other words a total number of scales, of a substrate to augment its sound attenuating performance without having to increase the size of the substrate.

Certain embodiments of the present invention may provide an apparatus that adds scales of heterogeneity to a 2-scale heterogeneous material via the addition of at least one inclusion of at least one multi-scale heterogeneous material to increase the sound attenuating performance of the 2-scale heterogeneous material, particularly for attenuating low frequency sound waves.

Certain embodiments of the present invention improve the sound attenuating characteristics of conventional sound absorbing materials by introducing one or more regions of a further material into a substrate body. Aptly, the further material introduces one or more extra scales of heterogeneity to the substrate.

Certain embodiments of the present invention may provide a convenient and inexpensive method of manufacturing a sound attenuating body that improves the sound attenuating capacity of conventional sound attenuating, heterogeneous materials.

Certain embodiments of the present invention may provide a method and apparatus for attenuating sound, particularly at low frequencies, across a cavity construction in a building or vehicle.

Certain embodiments of the present invention may provide a method of increasing sound transmission loss through an existing cavity construction in a building or vehicle without having to increase the volume of the cavity itself.

Certain embodiments of the present invention may shift a first resonant frequency of a cavity construction towards a lower frequency whilst increasing the transmission loss of sound waves having a frequency which is at and above the shifted resonant frequency to thereby increase the sound attenuation performance of the cavity construction particularly in relation to low frequency sound waves.

### BRIEF DESCRIPTION OF DRAWINGS

Embodiments of the present invention will now be described hereinafter, by way of example only, with reference to the accompanying drawings in which:

FIG. 1 illustrates an exploded view of a sound attenuating apparatus according to certain embodiments of the present invention;

FIG. 2 illustrates the apparatus of FIG. 1 wherein a portion of the closure layer is removed for illustrative purposes only;

FIG. 3 illustrates a plan view of a sound attenuating apparatus according to a further embodiments of the present invention in which regions of a multi-scale heterogeneous material are carried on a thin membrane layer;

FIG. 4 illustrates an exploded view of a sound attenuating apparatus according to further embodiments of the present invention which comprises the membrane layer of FIG. 3;

FIG. 5 illustrates the apparatus of FIG. 4 in an assembled state;

FIG. 6 illustrates alternative configurations and arrangements of the regions of multi-scale heterogeneous material according to certain embodiments of the present invention;

FIG. 7 illustrates further alternative configurations and arrangements of the regions of multi-scale heterogeneous material according to certain embodiments of the present invention;

FIG. 8a illustrates the normal incidence sound absorption coefficient of a rigidly-backed layer of a composite material according to certain embodiments of the present invention and that of the substrate only;

FIG. 8b illustrates the average improvement in normal incidence sound absorption coefficient of different configurations of composite in the frequency range 20 to 400 Hz;

FIG. 8c illustrates the normal incidence sound transmission loss of a layer of a composite material according to certain alternative embodiments of the present invention and that of the substrate only;

FIG. 8d illustrates the average improvement in normal incidence sound transmission loss of different configurations of composite in the frequency range 20 to 400 Hz;

FIG. 9 illustrates a building having improved sound attenuation performance according to certain embodiments of the present invention;

FIG. 10 illustrates sound transmission loss against frequency for an empty double partition having a resonant frequency of about around 80 Hz;

FIG. 11 illustrates sound transmission loss against frequency for a double partition having 3 mm steel panels and a cavity width of 5 cm compared with a double partition having the same steel panels and a cavity width of 20 cm;

FIG. 12 illustrates sound transmission loss against frequency for a double partition having 3 mm steel panels and an empty 5 cm cavity compared with the same double partition having a cavity filled with an adsorbing porous material;

FIG. 13 shows a double partition filled with a composite material including a substrate of foam or fibrous material and an inclusion of activated carbon;

FIG. 14 illustrates sound transmission loss against frequency for a double partition having 12.5 mm gypsum panels and an empty cavity of 5 cm (continuous line) compared with the same cavity filled with a foam material (dotted line) and a composite of foam and an inclusion of activated carbon (dashed line); and

FIG. 15 illustrates sound transmission loss against frequency for a double partition having 12.5 mm gypsum panels and an empty cavity of 5 cm (continuous line) compared with the same cavity filled with a fibrous material (dotted line) and a composite of fibrous material and an inclusion of activated carbon (dashed line).

### DESCRIPTION OF EMBODIMENTS

In the drawings like reference numerals refer to like parts.

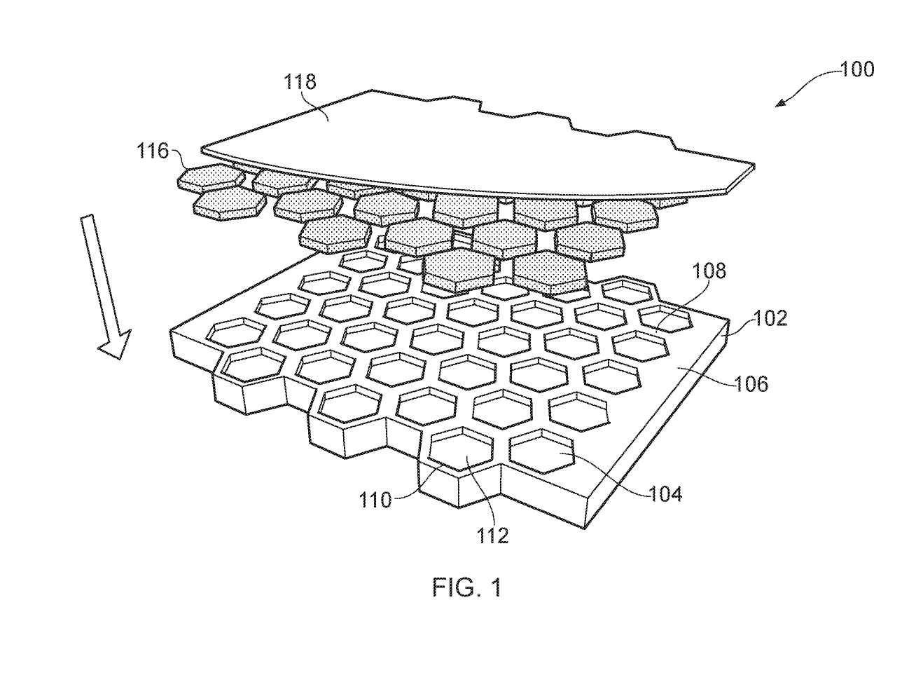

FIG. 1 illustrates a sound attenuating apparatus 100 according to certain embodiments of the present invention. The apparatus includes a foam substrate layer 102. This is a 2-scale heterogeneous material. Aptly, the substrate could be another type of 2-scale heterogeneous material, such as a foam, mineral wool, glass wool, or the like. Aptly, the substrate may be a porous non-woven material. The substrate has a number of recesses 104 extending inwardly from an outer surface 106 of the substrate layer 102. The outer surface 106 is a sound receiving surface, i.e. a surface of the substrate layer that in use is arranged to face the approaching sound waves. The thickness of the substrate layer 102 is about around 20 cm but may vary depending on the technical application and sound attenuation performance required. For example, the thickness of the substrate layer 102 may be about around 1 to 100 cm, aptly about around 1 to 30 cm and further aptly about around 5 cm. Each recess 104 is about around 1-2 cm deep and about around 6-8 cm wide. However, like the range of thickness of the substrate layer, the depth and width of each recess may vary and each is aptly about around 95% or less than a thickness and width of the substrate layer 102 respectively. The recesses 104 are spaced apart to form a waffle-type substrate structure having wall portions 108 extending between each recess. The wall portions 108 are about around 1-2 cm thick. However, aptly the wall portions 108 may be less than 1 cm thick. Aptly, the recess spacing and thus the thickness of the wall portions 108 are no less than about around 3 times the mesoscopic characteristic size of the heterogeneous material that constitutes the inclusions 116 (described below) but not smaller than about around 3 times the microscopic characteristic size of the heterogeneous material that constitutes the substrate layer 102.

Each recess 104 has an opening 110 providing an open mouth for receiving a respective region of multi-scale heterogeneous material, such as activated carbon 116, and a base 112 to contain and/or support the region of activated carbon in at least in a downward direction into the substrate. Each recess 104 is complementarily shaped with a respective region of activated carbon. For example, as shown in FIG. 1, each region of activated carbon 116 and each recess 104 are both substantially hexagonal to cooperate with one another and to prevent rotation of a region of activated carbon 116 when located in a respective recess 104. The recesses and regions of activated carbon may however be any suitable or desired shape or cross section, such as circular, square, triangular, cylindrical, disc-like, annular, arbitrary contour, or the like, to define a grid-like, honeycomb, or the like, substrate. The composite body 100 may include a sintered glass fibre honeycomb substrate 102 that reinforces the composite body 100 whilst carrying the inclusions 116 of activated carbon in granular or monolith form.

It will be understood that a ‘heterogeneous material’ is a material that includes a skeletal portion, which may be referred to as the ‘solid frame’, and many voids (pores) which are typically filled with a fluid to define a fluid network. The term ‘heterogeneous material’ describes the geometric scale of a material that creates the voids or cavities and in turn defines a porosity of the material, i.e. the term is used to describe a similarity of void geometry scale within a porous solid.

Heterogeneous materials, such as cellular, fibrous, granular or porous materials, have been conventionally used for acoustic treatment because of their sound absorptive and sound insulating properties. A porous material can be defined as a solid or elastic frame with holes saturated by a fluid. These holes are often called pores and form a fluid network. This network can be either connected or unconnected. Fibrous or granular materials are better described as assemblies of solid or elastic inclusions surrounded by a fluid network. A cellular material can be defined as a cluster of cells (or small compartments) with solid or elastic edges or faces, packed together so that they fill the space.

Despite the evident differences in morphology of these type of materials, a sample size, a characteristic size, and porosity can be defined. Porosity is given by the ratio between the volume occupied by the fluid and the total volume of the material. The characteristic size can be defined as a meaningful value representing their uni-modal cell, fibre, particle, or pore size distribution. For heterogeneous materials these characteristic sizes may take values ranging from nanometres to millimetres, while the porosity can take values close to zero, e.g. consolidated granular materials, and close to one, e.g. fibrous or cellular materials. The sample size can normally take values ranging from millimetres to less than a metre.

It will also be understood that these heterogeneous materials can have different scales of heterogeneity, such as mesoscopic, microscopic and nanoscopic, and a macroscopic scale related to the sample size. For example, a conventional 2-scale or single porosity material, such as foam, mineral wool or the like, has a solid frame of the constituent material and many pores or voids at a microscopic scale and a macroscopic scale related to the sample size. Whereas, 3-scale (double porosity) materials (such as expanded perlite, vermiculite or the like) and 4-scale (triple porosity) materials (such as activated carbon, activated charcoal or the like) have three or more scales of heterogeneity respectively, i.e. macroscopic, mesoscopic and microscopic for 3-scale materials and macroscopic, mesoscopic, microscopic and nanoscopic for 4-scale materials.

It will also be understood that an ‘effective’ number of scales of heterogeneity refers to a total number of scales of a composite material according to certain embodiments of the present invention made up of two or more different heterogeneous materials each having a different number of scales of heterogeneity. For example, a sound absorbing structure according to certain embodiments of the present invention made up of a substrate formed from a 2-scale material, such as foam, fibrous material or the like, and inclusions of a 4-scale material, such as activated carbon, activated alumina or the like, will have an effective number of scales of 6, i.e. the composite material will have 6 scales of heterogeneity. The six scales would be: macroscopic scale of the overall composite material (related to the sample size, e.g. layer thickness), mesoscopic scale of the overall composite material (related to the characteristic size of the inclusions, e.g. inclusion size), microscopic scale of the substrate constituent material (related to the microscopic characteristic size of the substrate material, e.g. mean fibre or cell size), mesoscopic scale of the inclusion constituent material (related to the mesoscopic characteristic size of the inclusion constituent material, e.g. mean grain size), microscopic scale of the inclusion constituent material (related to the microscopic characteristic size of the inclusion constituent material, e.g. mean micropore size), and nanoscopic scale of the inclusion constituent material (related to the characteristic size of the inclusion constituent material, e.g. mean nanopore size).

It will be understood that there are two different ways of characterising or describing a multi-scale material. One of these ways is in terms of the characteristic sizes at the different scales described above and the associated porosities, while the other way is in respect of the macroscopic properties of the material that are measured using standardised methods. These macroscopic properties are dependent on the microstructure of the material.

For example, at a macroscopic scale of a composite sound attenuating material comprising a 2-scale material substrate and at least one 4-scale material inclusion according to certain embodiments of the present invention, the thickness of the composite material is substantially no less than about around 1 millimetre and substantially no more than 1 metre. Aptly, the layer thickness of the composite material is less than about around 10 cm. The porosity of the composite material is substantially no less than 0.01 but substantially no greater than 0.999. Aptly, the porosity value is within the range from about around 0.7 to about around 0.999. Aptly, the porosity value may be less than 0.7.

At a mesoscopic scale of the composite material, the smallest dimension of the inclusions can take values ranging from about around 3 times the mesoscopic characteristic size of the inclusion material up to about around 0.9999 times the thickness of the composite material. The largest dimension of the inclusions can take values ranging from about around 0.01 to about around 0.9999 times either the thickness or the width of the composite material. The minimum edge-to-edge distance of the inclusions can take values ranging from about around 3 times the mesoscopic characteristic size of the inclusion material and about around 0.999 times either the layer thickness or the width of the composite material. Aptly, the volume fraction occupied by the inclusions in the composite material is larger than about around 1-5% but smaller than about around 99.999% of the total volume of the composite material. Aptly, to help maximise the low frequency sound attenuation of the composite material according to certain embodiments of the present invention, it is desirable to maximise the volume fraction occupied by the inclusions. The total porosity of the inclusion material can take values from about around 0.01 up to about around 0.999. Aptly, the value of porosity is about around 0.84.

At a microscopic scale of the substrate, the microscopic characteristic size of the substrate material is substantially no less than about around 0.1 micrometre and substantially no greater than about around 10 millimetres. It is understood that this value corresponds to a meaningful value calculated from the unimodal size distribution of the 2-scale substrate material. This value may represent the mean cell size in a cellular material, the mean fibre size in a fibrous material, the mean grain size in a granular material, or the mean pore size in a porous material. Aptly, the values are about around 6 micrometre for fibrous materials, about around 48 micrometre for cellular materials, about around 0.5 mm for granular materials, and about around 50 micrometre for porous materials. The porosity of the substrate can take values in between about around 0.01 and about around 0.999. Aptly, the porosity value is about around 0.98 for cellular materials, about around 0.98 for fibrous materials, about around 0.32 for granular materials, and about around 0.65 for porous materials.

At a mesoscopic scale of the 4-scale inclusion material, e.g. activated carbon, the mesoscopic characteristic size of the inclusion material (e.g. mean grain size) can take values from about around 0.1 micrometre up to about around 10 millimetres. Aptly, the mesh size determining the grain size distribution is about around 30×70, i.e. a mean grain size is about around 0.3 mm. The mesoscopic porosity of the inclusion material can take values from about around 0.01 up to about around 0.6. Aptly, the porosity value is about around 0.3.

At a microscopic scale of the inclusion material, the microscopic characteristic size (e.g. micropore size) of the inclusion material can take values from about around 50 nanometre up to about around 50 micrometre. Aptly, the value is about around 0.2 micrometre. The microscopic porosity of the inclusion material can take values from about around 0.01 up to about around 0.999. Aptly, the value is about around 0.65.

At a nanoscopic scale of the inclusion material, the nanoscopic characteristic size (e.g. nanopore size) of the inclusion material can take values from about around 0.01 nanometre up to about around 50 nanometre. Aptly, the value is about around 2 nanometre. The nanoscopic porosity of the inclusion material can take values ranging from about around 0.01 up to about around 0.999. Aptly, the value is about around 0.3.

It is understood that the values of the characteristic sizes of the inclusion material correspond to meaningful values calculated from the multimodal characteristic size distribution of the inclusion material.

Aptly, the mesoscopic characteristic size of the inclusion material is about around 1000 times larger than the microscopic size of the inclusion material. Aptly, the microscopic characteristic size of the inclusion material is about around 100 times larger than the nanoscopic characteristic size.

The alternative way of describing a multi-scale material of apparatus according to certain embodiments of the present invention in terms of macroscopic properties that are measured using standardised methods will now be described.

A flow resistivity of the substrate material can take values ranging from about around 0.01 Rayls up to about around 1 MRayls. Aptly, the value is about around 1 kRayls for cellular materials, about around 15 kRayls for fibrous materials, about around 40 kRayls for granular materials, and about around 90 kRayls for porous materials. The flow resistivity of the inclusion material can take values ranging from about around 0.01 Rayls up to about around 1 MRayls. Aptly, the flow resistivity is about around 96 kRayls. The flow resistivity of the inclusion material is aptly no smaller than that of the substrate material.

The N2 surface area of the inclusion material aptly may take values ranging from about around 0.01 m̂2/g up to about around 7000 m̂2/g. Aptly, the N2 surface area is as large as possible.

The nanopore volume of the inclusion material may aptly take values ranging from about around 0.01 cm̂3/g up to about around 2 cm̂3/g. Aptly, the nanopore volume is as large as possible.

It is further understood that ‘acoustically transparent’ or ‘substantially permeable’ means that the material according to certain embodiments of the present invention has a low flow resistance (which is defined as thickness times the flow resistivity). The flow resistance is aptly less than about around 300 kg/s/m and aptly the flow resistance is as small as possible.

It will also be understood that, whilst certain embodiments of the present invention described herein refer to at least one region of activated carbon, other examples of multi-scale heterogeneous materials can be used, such as expanded perlite, vermiculite, cenospheres, clay, vycor, zeolites, aerogels, metal-organic frameworks, coal, activated alumina, silicalite, activated charcoal or the like. The term ‘activated carbon’ in accordance with certain embodiments of the present invention relates to a family of carbonaceous materials specifically activated to develop strong sorptive properties whereby even trace quantities of fluid may be adsorbed onto the carbon. Such activated carbons may be produced from a wide range of sources, for example coal, wood, nuts (such as coconut) and bones and may be derived from synthetic sources such as polyacrylonitrile or the like. Various methods of activation exist, such as selective oxidation with steam, carbon dioxide or other gases at elevated temperatures or chemical activation using, for example, zinc chloride or phosphoric acid.

The at least one region of activated carbon 116 may consist of grains or fibres contained by a suitable containing member, such as a sound permeable/transparent membrane or fine mesh-like structure. The individual grains or fibres are held securely together by such a containing member whilst providing many small, low volume inter-granular voids that make up a scale of heterogeneity that significantly improves the noise attenuation performance of each region of activated carbon and subsequently of the composite material.

Alternatively, the at least one region of activated carbon 116 may comprise a monolith of activated carbon comprising many small, low volume, interconnected pores that significantly increase the fluid containing volume, e.g. for containing air, to provide the interconnecting air paths forming the fluid network for improved sound attenuation.

Further alternatively, a combination of spaced apart granular regions and/or monolith regions of activated carbon, or other multi-scale heterogeneous material, can be envisaged as being introduced into a substrate body.

The presence of each spaced apart region of activated carbon 116 or other multi-scale heterogeneous material in the substrate layer 102 increases the total number of scales of the composite material and in turn the sound attenuation performance of the resultant composite body 100 (relative to the substrate layer 102 without any regions of activated carbon) without having to substantially increase the overall size, and in particular the depth/thickness, of the substrate layer.

Each region of activated carbon 116 is inserted into a respective recess 104 and a closure layer 118 of heterogeneous material is placed on the outer surface 106 of the substrate layer 102. The heterogeneous material of the closure layer 118 may be the same as or different to the heterogeneous layer of the substrate layer 102. The closure layer may be a substantially low flow resistance material, such as foam or mineral wool or the like. Aptly, the closure layer 118 may be about around 5 mm thick and aptly no more than about around 1 cm thick. However, aptly the closure layer may be less than 5 mm thick and about around 1 mm thick. The substrate layer 102, inclusions of activated carbon 116 and the closure layer 118 are then pressed through rollers at about around 140° C. (or other suitable temperature depending on the materials of the closure layer and/or substrate) to attach the closure layer 118 to the outer surface 106, and in particular the wall portions 108, of the substrate layer 102. The outer surface 106 of the substrate may be pre-coated with a binder which is cured to bind the closure layer 118 to the substrate 102. Alternatively, the material of the closure layer and substrate may interact upon heat and/or pressure to bind the two components together without compromising the integrity of the regions of activated carbon. Further alternatively, an adhesive layer or coating may be located between the substrate and closure layer to adhere the two components together, or the two layers may be fused together using ultrasonic welding.

According to certain embodiments of the present invention, a substrate of fibrous material, such as mineral wool, may be pressed into a waffle-like or honeycomb-like tray form using metal plates heated to a sufficient predetermined temperature to sinter the glass wool fibres into a porous fibrous glass shell defining the spaced apart compartments. The compartments can thus effectively contain activated carbon in granular or monolithic form. The fibrous glassy shell of the formed substrate may also form an appropriate outer surface for a thin closure layer of fibrous material, such as mineral wool, to seal against. To allow the augmented mineral wool substrate to be workable and easily cut into different lengths without compromising the integrity of the regions of activated carbon, the hot metal plates may also form spaced apart lines of perforations through the substrate and closure layer to allow sections of the substrate including a predetermined number of compartments including activated carbon to be easily separated by hand. Such perforations aptly extend through the substrate and closure layer and may have fine non-structural fibrous and/or fine porous membranes covering each open end of each perforation to prevent air flow through the substrate.

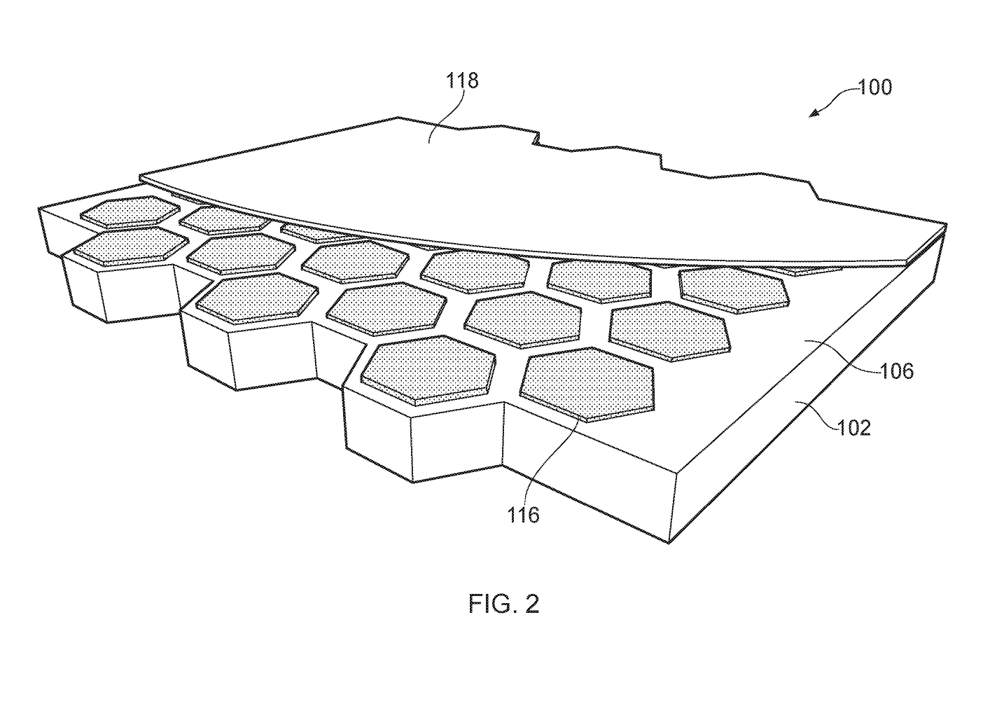

An assembled sound attenuating body 100 assembled in this way according to certain embodiments of the present invention is illustrated in FIG. 2.

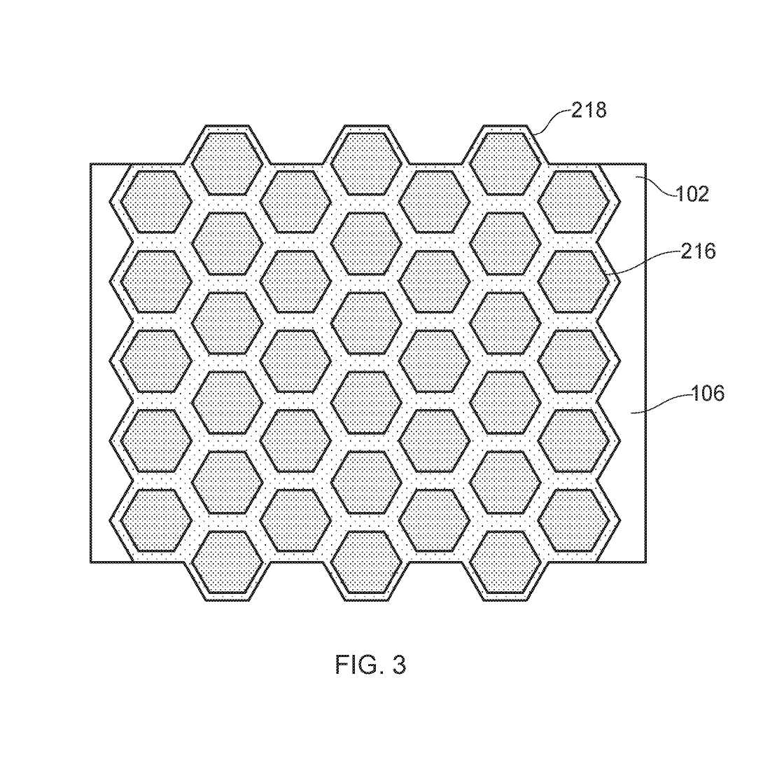

As illustrated in FIG. 3, a further embodiment of the present invention provides a closure layer 318 which comprises a thin membrane layer which is substantially acoustically transparent and/or substantially permeable to sound. The closure layer 318 may comprise a 2-scale heterogeneous woven, non-woven and/or fine gauze material, for example. Each recess may alternatively be a through hole in the substrate and each region of activated carbon may be securely located in a respective through hole by adhesive and/or a closure layer on one or both sides of the substrate.

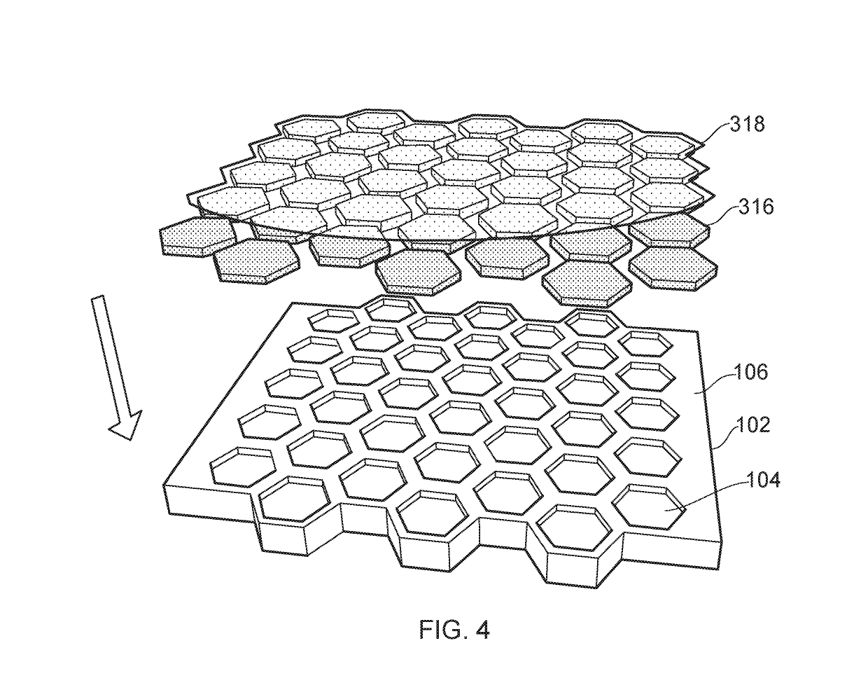

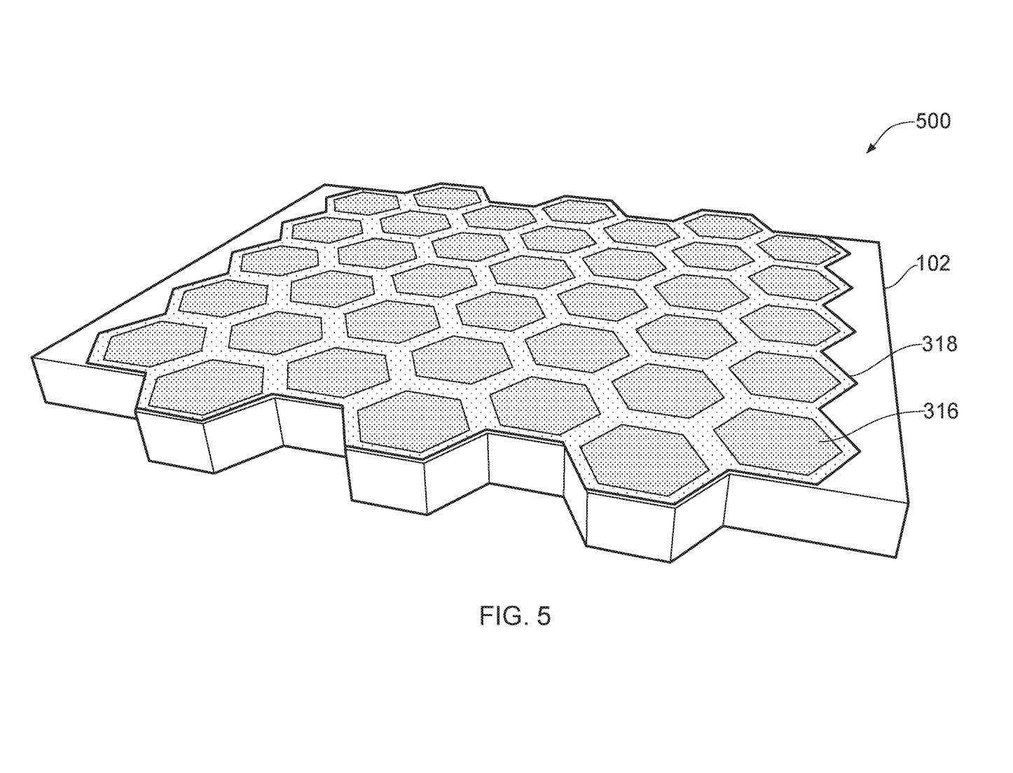

As illustrated in FIG. 4, each region of activated carbon 316 is attached to and carried by the closure layer 318 such that when the closure layer 318 is offered up to the outer surface 106 of the substrate layer 102, each region of activated carbon 316 is aligned with a respective recess 104 in the substrate layer 102 and located therein. The closure layer 318 is then attached to the substrate layer 102 to close the recesses and secure the regions of activated carbon 316 therein. An assembled sound attenuating body 500 according to certain embodiments of the present invention is illustrated in FIG. 5. Such a body 500 may be located in the cavity of a cavity construction, such as a double partition wall, floor or ceiling in a building or in the cavity defined between two panels/walls of a vehicle closure (door, hood or decklid, pillars, sills or the like), body or chassis for noise attenuation purposes such as minimising or preventing low frequency noise entering the cabin.

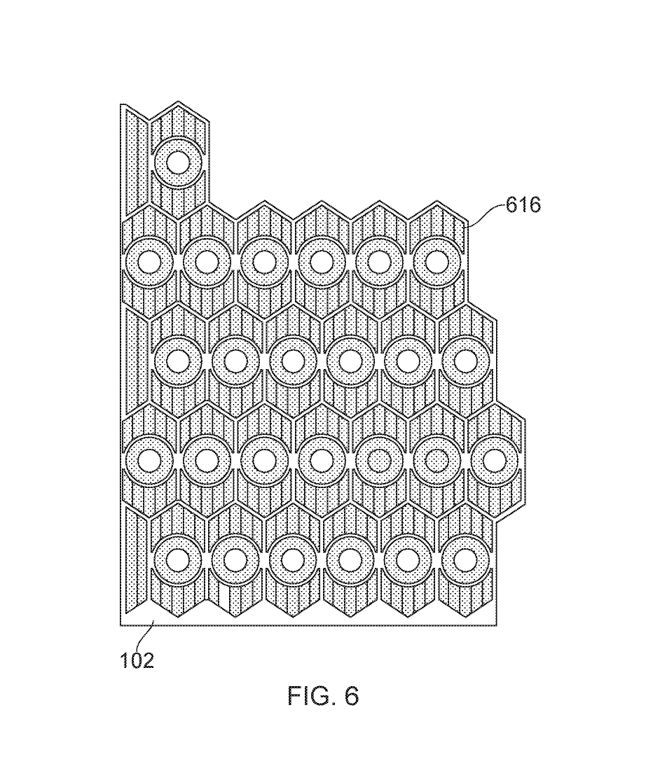

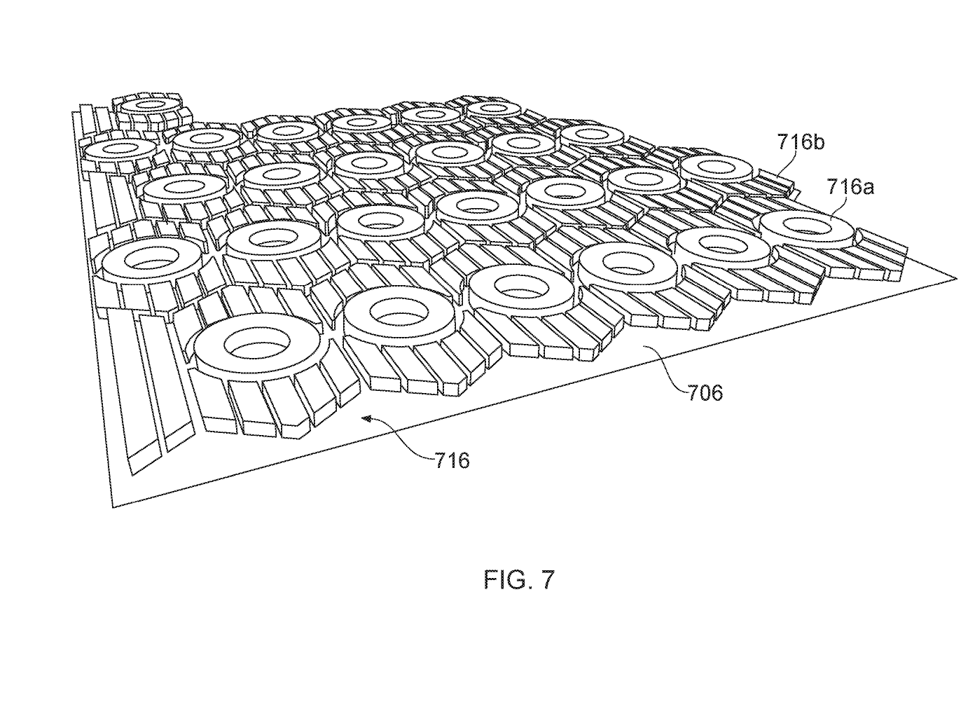

As illustrated in FIGS. 6 and 7, a number of different arrangements and configurations of the regions of activated carbon 616 on the closure layer and/or the recesses 104 in the substrate layer 102 can be selected responsive to the desired sound attenuating performance of the apparatus and/or the desired aesthetics of the apparatus or the like. For example, each region of activated carbon 616 may take many different forms and shapes and may be arranged to form a variety of patterns when located in the substrate layer 602. The regions may be arranged to define a corporate logo or name for example. In the example shown, the regions of activated carbon have circular and orthogonal cross sections but many other shapes and cross sections can be envisaged. The regions of activated carbon 616 may also have different heights such that when located in respective recesses in the substrate layer, some regions 716a of activated carbon extend a greater distance from the outer surface 706 of the substrate layer than other regions 716b of activated carbon, as shown best in FIG. 7. As an alternative, some or all regions may be inset with respect to each other and/or the front surface of the substrate. Such an arrangement may for example allow the raised regions 716a to act to space a facing element (not shown), such as a protective grille, from the apparatus thereby to provide an air gap between the facing element and the substrate which may act as a vapour gap or for additional acoustic performance or the like. The regions of activated carbon may be arranged in an established or ordered pattern or be randomly distributed. Aptly, the regions of activated carbon are spaced from each other by a distance of about around three times the mesoscopic characteristic size of the constituent material of each region (inclusion) of activated carbon.

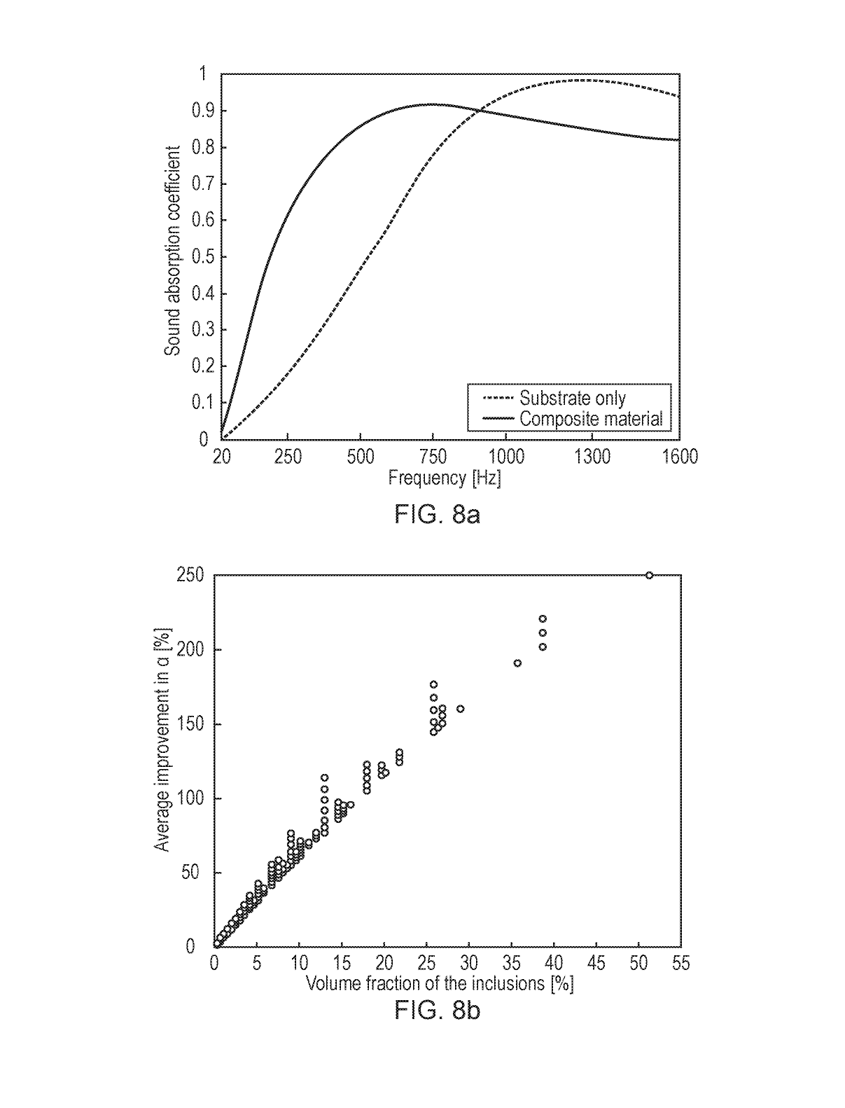

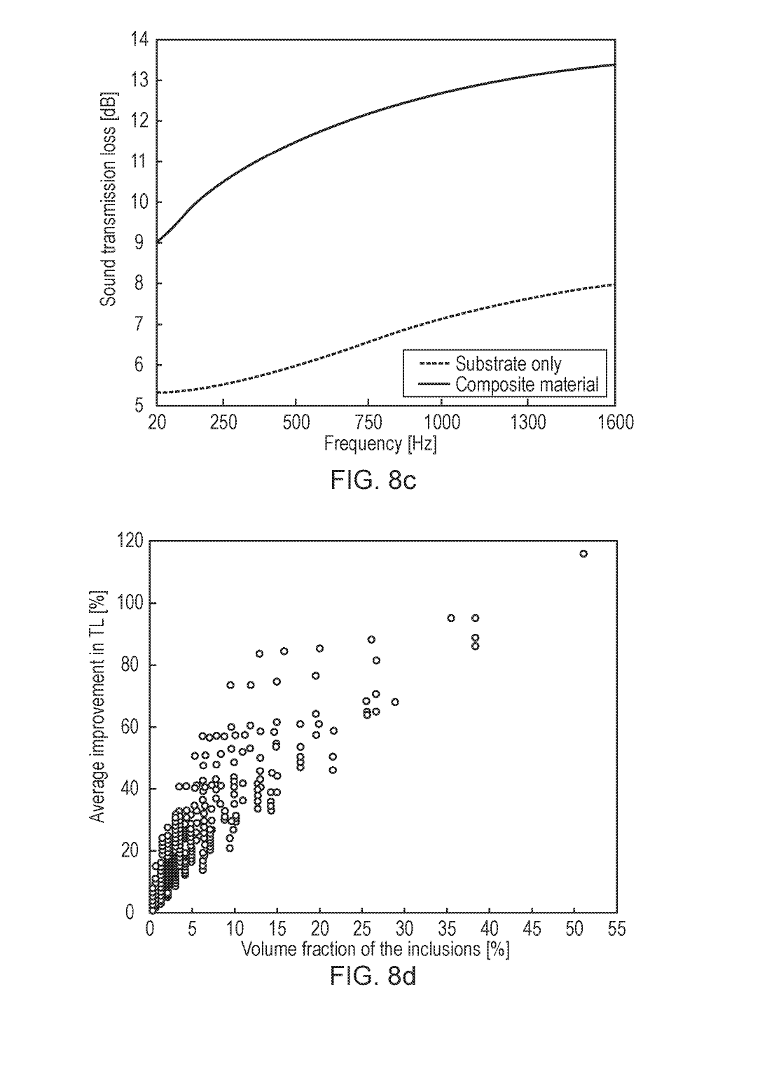

FIG. 8a illustrates a comparison between the normal incidence sound absorption coefficient of a rigidly-backed layer of a composite material according to certain embodiments of the present invention and of the substrate only. The composite material significantly outperforms the substrate at low frequencies. The substrate only is an open-cell foam and has a layer thickness of about around 5 cm and a flow resistivity of about around 1.7 kRayls. In accordance with certain embodiments of the present invention, inclusions of activated carbon have been introduced in this substrate. The resulting composite material has a layer thickness of about around 5 cm. The inclusions dimensions are cylindrical in shape with a radius of about around 4 cm and a thickness of about around 3 cm. The inclusions are placed about around 5 mm beneath the sound receiving outer surface of the substrate and the minimum edge-to-edge distance is about around 2 cm. The inclusions occupy about around 38.4% of the total volume of the material. The most relevant parameters of the activated carbon sample are: flow resistivity of about around 96 kRayls; a total porosity of about around 0.84, and a nanopore volume of about around 0.784 cm̂3/g.

FIG. 8b illustrates the average improvement in normal incidence sound absorption coefficient of a rigidly-backed layer of a composite material in accordance with certain embodiments of the present invention with respect to the substrate only as a function of the volume fraction of the inclusions. The average has been taken over the frequency range of 20 to 400 Hz. The substrate material and the inclusion materials are the same as those shown in FIG. 8a, i.e. the substrate material is an open-cell foam and the inclusion material is activated carbon. The composite material provides a significant improvement of the low frequency sound absorption over the substrate material without inclusions. For example, a composite material could provide an improvement of more than about around 200% if the inclusions occupy about around 38.4% of the total volume of the composite material.

FIG. 8c illustrates a comparison between the normal incidence sound transmission loss of a layer of composite material with that of the substrate only. The composite material significantly outperforms the substrate. The substrate only is a fibrous material (glass wool). Its layer thickness is about around 5 cm and flow resistivity is about around 14 kRayls. The same activated carbon sample as in FIG. 8a has been considered.

FIG. 8d illustrates the average improvement in sound transmission loss of a layer of a composite material with respect to the substrate only as a function of the volume fraction of the inclusions. The average has been taken over the frequency range 20 to 400 Hz. The substrate material and the inclusion materials are the same as those shown in FIG. 8c, i.e. the substrate material is a fibrous material (glass wool) and the inclusion material is activated carbon. The composite material provides a significant improvement of the normal incidence sound transmission loss over the substrate material. For example, a composite material could provide an improvement of more than about around 200% if the inclusions occupy about around 38.4% of the total volume of the composite material.

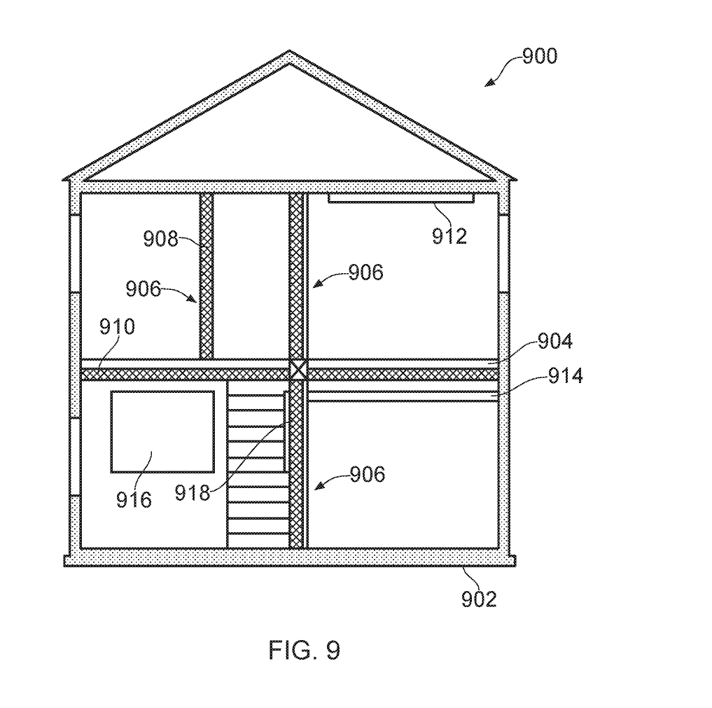

Thus, a sound attenuating apparatus according to certain embodiments of the present invention may have improved sound attenuation properties without an increase in at least size relative to conventional materials. The sound attenuating performance of a conventional 2-scale porous material may be significantly improved by the presence of spaced apart regions of a 3- and/or 4-scale porous material, such as expanded perlite and/or activated carbon, or the like, without having to increase the size and in particular the depth or thickness of the substrate material. The sound attenuating apparatus according to certain embodiments of the present invention may have many applications in, for example, the building, automotive, rail, aerospace industries, or the like, for sound absorption and sound transmission loss purposes and may form at least a part of a component or system therefor, such as a louvre of an air conditioning vent, a vehicle panel or trim component, cavity wall insulation or a floor, wall, door and/or ceiling panel, or the like. For example, as illustrated in FIG. 9, a building 900 has a ground floor 902 and first floor 904 and a number of cavity walls 906 to define ground and first floor rooms. The cavity walls 906 comprise a pair of opposed plasterboard layers and a layer of acoustic material 908 at least partially filling the cavity between the plasterboard layers. Alternatively, the acoustic material may be located on an outer surface of the wall. The acoustic material 908 comprises apparatus according to certain embodiments of the present invention for reducing sound transmission through the wall from one room to another. The same or similar acoustic insulating material according to certain embodiments of the present invention is also located in the floor cavities 910 to reduce sound transmission therethrough. Acoustic apparatus according to certain embodiments of the present invention is also located on the ceilings and/or walls of the building 900 to absorb sound being generated within a room and prevent reflection of that sound from a wall, floor and/or ceiling of that room. For example, as illustrated in FIG. 9, a sound absorbing panel 912 according to certain embodiments of the present invention is attached to a ceiling of a room. In another room, an acoustic absorbing layer 914 according to certain embodiments of the present invention is suspended from the ceiling of that room. In a further room, an acoustic absorbing panel 916, 918 is attached or hung from one or more walls of the room to absorb sound generated within the room. The apparatus according to certain embodiments of the present invention may take the form of a bass absorber, for example.

Whilst certain embodiments of the present invention have been described with respect to use of a substantially planar substrate it will be appreciated that such substrates can have any shape including moulded bodies having specific shapes and configurations to fit at desired locations in a space. For example, shaped body parts for automotive vehicles or the like.

In accordance with certain embodiments of the present invention, a sound attenuating body of at least one material may be located in the cavity of a cavity construction to attenuate noise transmission through the cavity construction. An example of such a body is described above with reference to at least FIG. 5. An example of such a cavity construction is a cavity wall in a building.

The partition leaves of a conventional cavity wall construction in a building are typically plasterboard which is available in different thicknesses ranging from about around 8-15 mm. The plasterboard is generally fixed with nails, screws or staples to opposite faces of timber studwork that forms a frame structure of the cavity wall. The partition leaves are substantially parallel to each other. The side faces of the studwork frame and plasterboard are attached to the floor, ceiling and adjacent walls such that a cavity is provided between the plasterboard panels. The cavity typically has a depth (separation distance between the two partition leaves) that is substantially less than a length and width of the partition leaves to thereby provide a relatively thin/slim/slender cavity construction. Aptly, the cavity construction when in use includes no substantial gaps or holes in and around the outer faces of the plasterboard to thereby provide a substantially closed and ‘acoustically sealed’ cavity because a hole in one of the plasterboard panels for example may render the construction not suitable for sound attenuation purposes. This is also desirable for automotive applications.

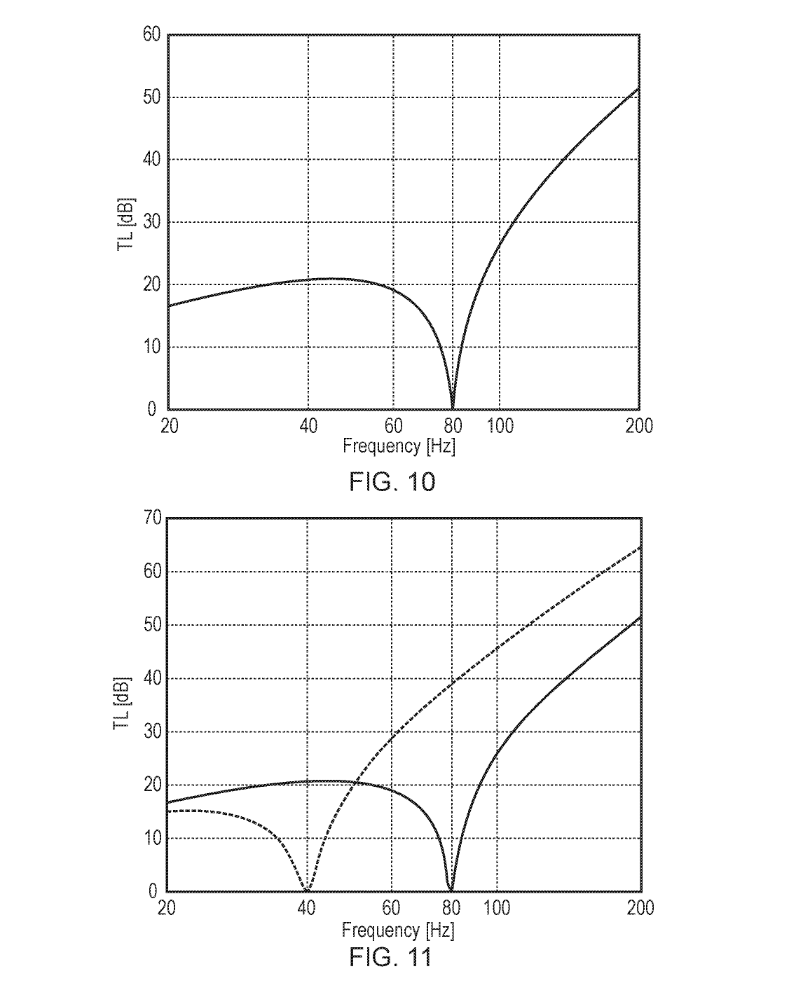

The two partition leaves of a conventional cavity wall construction are connected by a body of air within the cavity which behaves like a spring that ‘acoustically’ connects the partition leaves together and, like any spring and mass arrangement, the system will resonate at a particular frequency, which is normally called the mass-air-mass resonant frequency fᵣ. At this frequency, the two partition leaves will vibrate in unison and transmission loss will tend towards zero (see FIG. 10).

A known estimation for fᵣ is given by:

$${f}_{r} = \frac{1}{2 π} \sqrt{k / M} , \qquad ( 1 )$$

where k is the effective stiffness of the fluid (air) in between the partition leaves and M is the effective mass per unit area. The mass per unit area is given by:

$$M = \frac{{m}_{s 2} {m}_{s 1}}{{m}_{s 2} + {m}_{s 1}} , \qquad ( 2 )$$

where mₛ₁ and mₛ₂ are the mass per unit area of the two partition leaves respectively. The effective stiffness of air is given by:

k=K/d (3)

where K=γP₀ is the bulk modulus of air, d is the separation between the partition leaves, P₀ is the equilibrium pressure, and γ is the heat capacity ratio. For the example shown in FIG. 1, d=5 cm, mₛ₁=mₛ₂=22.5 kg/m̂2, and normal conditions were considered.

In accordance with conventional methods, the stiffness of the empty cavity construction can be reduced by increasing the separation between the partition leaves, i.e. increasing the volume of the cavity. The greater the distance between the partition leaves, the lower the mass-air-mass resonant frequency of the cavity construction and the greater the transmission loss (TL) at frequencies above this frequency are (see FIG. 11). Hence, for improved acoustic isolation, a conventional solution is to maximise the gap between the partition leaves but this is not particularly desirable, or in fact possible, in many building and vehicular applications.

If the cavity was filled with conventional porous material, such as a foam or a fibrous material for example, the mass-air-mass resonant frequency would also be provided by equation (1) above. However, the effective stiffness is given by:

k=K/d=P₀/φd (4)

where φ is the porosity of the porous filling material. This occurs because at low frequencies the effective bulk modulus of the porous layer takes the value K=P₀/φ since the sound propagation through the material is isothermal.

The ratio between the mass-air-mass resonant frequency fᵣₑ for an empty double partition to the mass-air-mass resonant frequency fᵣₚ of a partition filled with a conventional porous material is given by:

fᵣₑ/fᵣₚ=\sqrt{γφ} (5)

This indicates that by filling a cavity with an fluid (air)-saturated porous material with porosity larger than 1/γ=1/1.4=0.7143, such as a 2-scale fibrous or cellular material, e.g. foam, wool or the like, will always result in a decrease of the mass-air-mass resonant frequency compared with a cavity construction having an empty cavity. The ability of a conventional porous material to shift resonant frequency downward by a certain amount if porosity is above 0.7143 is understood by the skilled person and can be deduced from equation (5) above. However, the largest possible shift in resonant frequency has been found to be no greater than about around 15-20% of the mass-air-mass resonant frequency of the cavity construction. The reason for this is that the sound propagation in an empty cavity is adiabatic, while the sound propagation is isothermal when the cavity is filled with an air-saturated porous material.

When, in accordance with certain embodiments of the present invention, the cavity is filled with at least one region of sorptive porous material, such as activated carbon, activated alumina, expanded perlite, vermiculate, zeolites or the like, the mass-air-mass resonant frequency can be estimated by using equation (1) above, where the effective stiffness is provided by:

k=K/d=P₀/dφ(1+Ω²) (6)

where Ω is the ratio between two frequencies related to both sorption processes and the microstructure of the adsorbing porous material and can be obtained by measuring the static bulk modulus of the material using standardised conventional techniques.

This expression indicates that for larger values of Ω the cavity acoustically behaves much deeper than it physically is. The ratio between the mass-fluid(air)-mass resonant frequency of the empty cavity to that of the cavity filled with adsorbing porous material is provided by:

fᵣₑ/fᵣₛ=\sqrt{γφ(1+Ω²)} (7)

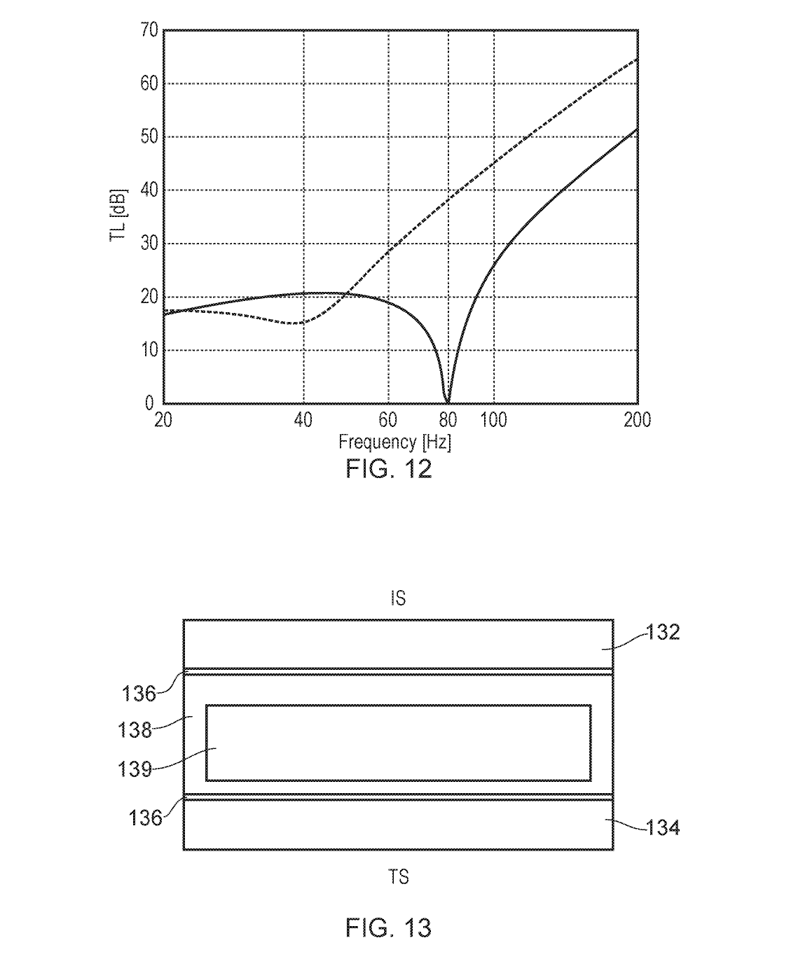

This expression indicates that there are two mechanisms contributing to the decrease in mass-air-mass resonant frequency: a) the heat conduction related effect of isothermal propagation through the adsorbing porous layer (instead of adiabatic sound propagation as in the case of an empty cavity); and b) the contribution of sorption effects. Depending on the value of Ω which may aptly be within the range of about around 10⁻³ to 10³, a much larger decrease in mass-air-mass resonant frequency can be achieved by filling (or partially filling) the cavity with a sorptive porous material. This is illustrated in FIG. 12.

As shown in FIG. 12, a 5 cm wide cavity between 3 mm thick steel panels (each having a mass per unit area of 22.5 kg/m̂2) and filled with activated carbon in granular form acoustically behaves as if it is much deeper than it physically is. In particular, the resonant frequency of the double partition construction is shifted downwardly from around 80 Hz to around 40 Hz and the transmission loss at the decreased resonant frequency is also significantly increased from 0 to around 15 dB. In order to match the same mass-air-mass resonant frequency, the empty cavity would have to be about around four times deeper (compare dashed lines in FIG. 11 and FIG. 12). A further advantage of including an adsorbing porous material is the enhanced sound transmission loss achieved at and around the shifted mass-air-mass resonant frequency compared to the transmission loss achieved by an empty cavity at its resonant frequency. As shown in FIG. 12, the minimum TL of the activated carbon configuration at around 35-40 Hz is much higher compared to the minimum TL of the empty configuration (which tends toward zero at 80 Hz, as shown). This technical effect is caused by the larger dissipation of low frequency sound energy achieved by the adsorbing porous material.

In accordance with certain embodiments of the present invention, a double panel including a pair of spaced apart 12.5 mm thick gypsum panels and having a cavity filled with a composite material of foam and an activated carbon inclusion has been numerically modelled using COMSOL Multiphysics® modelling software. FIG. 13 shows the geometry utilised. The two gypsum panels 132, 134 are modelled as isotropic elastic solids with the following properties: h₁=h₂=12 mm, E₁=E₂=2.1 GPa, v₁=v₂=0.3, ρ₁=ρ₂=710 kg/m̂3. The mass per unit area (or superficial density) of each panel is 8.52 kg/m̂2. A background pressure field was set up in the incident wave geometry side referenced as IS in the figure. The side of the model which is opposite to the incident side has been called the transmission wave geometry side and is referenced as TS in the figure.

The sound attenuating composite, in accordance with certain embodiments of the present invention, includes a foam substrate 138 and a single 20 mm thick inclusion 139 of granular activated carbon, and is located in the cavity defined between the two panels. The panels are separated by a distance of a=30 mm. Aptly, a small air gap 136 of 1 mm is provided in the model between the panels and the composite body to allow for mechanical decoupling. However, in accordance with certain embodiments of the present invention, the air gap may not be required or may be more or less than 1 mm.

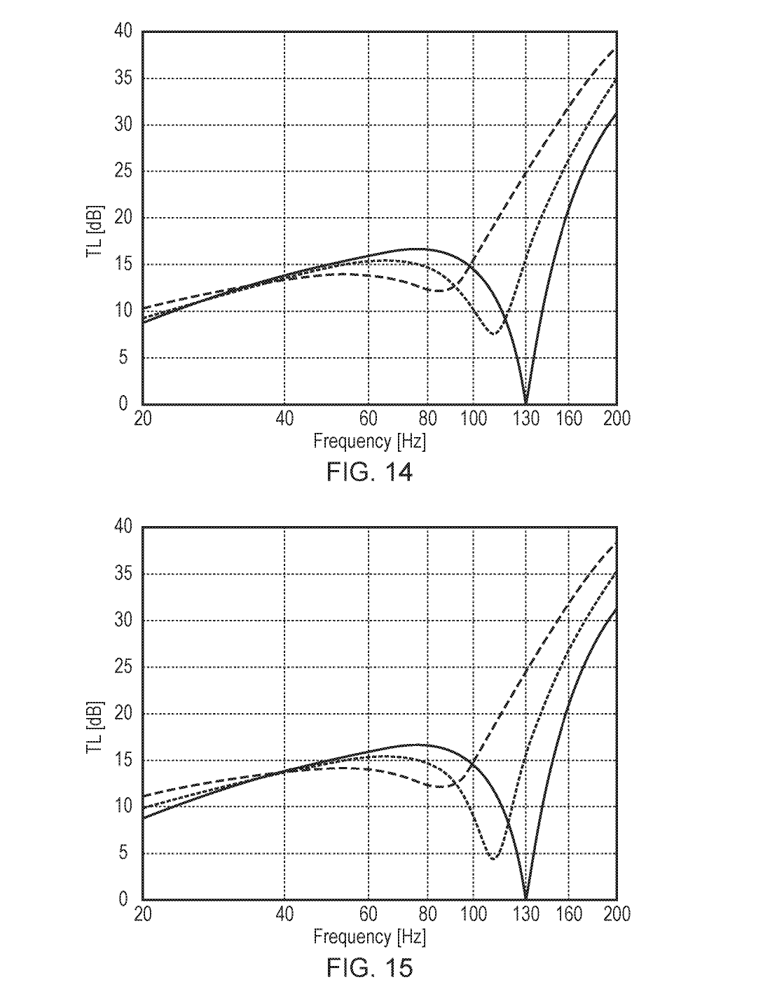

FIGS. 14 and 15 show the influence of adding inclusions of activated carbon to a foam substrate (FIG. 14) or fibrous substrate (FIG. 15) on the transmission loss (TL) of the double panel configuration compared to the cavity being empty (see continuous line) or filled with only foam or fibrous material (see dotted line). The width and thickness of the matrix (substrate) are 100 mm and 28 mm respectively and the width and thickness of the inclusions located in the matrix are 90 mm and 20 mm respectively.

The foam material has a bulk density of 52 kg/m³, flow resistivity of 6.9 kRayls and porosity of approximately 0.98. The fibrous material has a bulk density of 30 kg/m³, flow resistivity of 13.97 kRayls, and porosity of 0.98.

The activated carbon used for the purposes of describing certain embodiments of the present invention has a bulk density of about around 356 kg/m³ and parameters as listed in Table 1 below:

TABLE 1

| | | | | | | kₐ | |
|---|---|---|---|---|---|---|---|
| rₙ | | rₘ | | rₚ | | [Pa\hat{ }−1. | k_{d} |
| [nm] | φₙ | [μm] | φₘ | [mm] | φₚ | s\hat{ }−1] | [s\hat{ }−1] |
| 2.4278 | 0.2791 | 0.1886 | 0.6639 | 0.3062 | 0.3320 | 0.0369 | 48 |

wherein the listed parameters are particle radius rₚ, mesoscopic porosity φₚ, microscopic pore radius rₘ, microscopic porosity φₘ, nanoscopic pore radius rₙ, nanoscopic porosity φₙ, and the adsorption kₐ and desorption k_{d} coefficients.

The cavity construction with an empty cavity (continuous line) shows a transmission loss (TL) that is a minimum at the structural resonant frequency of around 130 Hz which is given by:

$${f}_{s} = \frac{1}{2 π} \sqrt{\frac{k}{m}} = \frac{1}{2 π} \sqrt{\frac{γ {P}_{0}}{a} \frac{{ρ}_{1} {h}_{1} + {ρ}_{2} {h}_{2}}{{ρ}_{1} {h}_{1} {ρ}_{2} {h}_{2}}} , \qquad ( 7 )$$

where the adiabatic exponent is γ=1.4 and the equilibrium pressure is P₀=101325 Pa.

Filling the cavity with foam or a fibrous material (width of 100 mm and thickness of 28 mm) improves the TL around the resonant frequency of the double panel structure (see dotted line in FIGS. 14 and 15). In addition, the resonant frequency is slightly shifted towards lower frequencies because of the large porosity of the foam or fibrous material in the cavity. This is caused by the fact that at low frequencies the sound propagation is isothermal inside the foam or fibrous material while it is adiabatic in the empty cavity construction.

In accordance with certain embodiments of the present invention, by adding activated carbon to the foam substrate, one can obtain a much larger shift of the resonant frequency towards low frequencies (see dashed line in FIGS. 14 and 15). The shifted and optimised resonant frequency can be calculated using expressions (1) and (7) above.

Adding inclusions of activated carbon to the substrate foam or fibrous material, wherein the inclusions occupy about around a third of the composite volume, results in a larger shift in resonant frequency and an improved sound transmission loss above this decreased resonant frequency compared to filling the cavity with foam or fibrous material only. The former is a direct consequence of the compliance enhancement provided by activated carbon which is in turn mainly caused by both the multi-scale nature of the material and sorption processes. Shifting the resonant frequency in accordance with certain embodiments of the present invention results in the latter, i.e. a larger TL obtained from that frequency onwards. In addition, the sound attenuation achieved by the composite itself contributes to increasing the TL at the resonant frequency, thereby ameliorating the overall performance of the configuration.

As described above, a region of absorptive material located in a cavity provided between two partition leaves substantially shifts the first resonant frequency of the cavity construction downwardly such that the first resonant frequency is further away from typical frequencies of sound waves, particularly low frequencies below about around 400 Hz, which are incident on the construction and attempting to pass through the construction. This in turn has the effect of attenuating typical sound frequencies which would otherwise cause an empty cavity construction to resonate and thus allow typical sound waves to transmit through the construction with around no transmission loss. In addition to the resonant shift, the presence of the adsorptive material in the cavity increases the sound transmission loss at and above the shifted resonant frequency meaning that, even if the shifted resonant frequency of the improved construction is reached by incident sound, a substantial transmission loss is achieved which is significant compared to the slightly improved transmission loss achieved by conventional sound insulation/absorbing materials such as foam or fibrous materials or the like. In view of the above technical effects, an existing cavity performs in terms of acoustic attenuation as if it was much larger and thus slender cavity walls, ceilings and floors can be constructed which possess much improved sound transmission loss qualities. This saves on material costs, weight and space. Furthermore, an existing partition construction does not need to be made larger to improve the sound attenuation performance thereof and thus limited additional space is not undesirably needed. The same advantages apply for vehicular applications or the like where cavity constructions are used and sound attenuation is important.

As also described herein, according to certain embodiments of the present invention, the region of adsorptive material located in the cavity of a double partition construction for example may be a monolithic slab of activated carbon or one or more parcels of granular activated carbon. Alternatively, as illustrated in FIG. 5 for example, a plurality of activated carbon inclusions may be at least partially located in a porous substrate or matrix material such as foam or fibrous materials or the like. The region of adsorptive material or composite material including one or more regions of adsorptive material may at least partially fill the cavity. For example, the sound attenuating material may extend from an inner surface of one of the partitions towards the other partition without contacting it, i.e. the sound attenuating material may extend partially across the cavity. Alternatively, a monolithic slab of adsorptive material or inclusion composite material may be sandwiched between two partition leaves which may be fixed to a structural component of the cavity construction, such as a timber stud, or to the sound attenuating material itself. The sound attenuating material may be formed such that it provides structural strength in a longitudinal direction whilst providing the sound attenuation performance described herein across a thickness of the sound attenuating material. The sound attenuating body may comprises a plurality of bodies that at least partially fill the cavity, such as foam balls of about around 2-10 mm diameter and having an activated carbon core. Such composite bodies may be located in a cavity of door pillar or sill of a vehicle or in a cavity wall, floor or ceiling of a building for example.

Whilst cavity walls in buildings and closure panels and bulkheads in vehicles have been used herein to describe certain embodiments of the present invention, other embodiments may include floor or wall mountable or ceiling hung sound attenuation panels, such as low frequency absorbers etc. Wall mountable sound attenuation panels may include graphics which could include a logo for advertising in a commercial environment or may include artwork for aesthetic purposes in a domestic environment. Floor mountable sound attenuation panels may include partitions locatable between desks and which at least partially extend from the floor towards the ceiling in an office environment. At least one sound attenuation body according to certain embodiments of the present invention may be located inside vehicle pillars, sills, components, or the like to attenuate noise transmission and vibration propagation.

Throughout the description and claims of this specification, the words “comprise” and “contain” and variations of them mean “including but not limited to” and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of the features and/or steps are mutually exclusive. The invention is not restricted to any details of any foregoing embodiments. The invention extends to any novel one, or novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1. Apparatus for attenuating sound, comprising:
at least one substrate element comprising at least one first heterogeneous material; and
at least one region comprising at least one further heterogeneous material at least partially located in the substrate element; wherein
said at least one further heterogeneous material has at least one more scale of heterogeneity than the at least one first heterogeneous material.

2. (canceled)

3. The apparatus as claimed in claim 1, wherein the at least one further heterogeneous material comprises at least one multi-scale heterogeneous material.

4. The apparatus as claimed in claim 2, wherein the at least one first heterogeneous material comprises a 2-scale heterogeneous material and the at least one further heterogeneous material comprises at least one 3-scale heterogeneous material and/or or at least one 4-scale heterogeneous material.

5. The apparatus as claimed in claim 1, wherein the at least one further heterogeneous material comprises at least one sorptive material.

6. The apparatus as claimed in claim 4, wherein the at least one further heterogeneous material comprises an adsorptive material.

7. (canceled)

8. (canceled)

9. (canceled)

10. (canceled)

11. The apparatus as claimed in claim 1, wherein the at least one region of further heterogeneous material comprises a unitary element of the further heterogeneous material.

12. (canceled)

13. The apparatus as claimed in claim 1, wherein the at least one further heterogeneous material comprises activated carbon.

14. The apparatus as claimed in claim 1, wherein the at least one first heterogeneous material comprises a 2-scale fibrous or cellular material.

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. A method of manufacturing a sound attenuating body, comprising:
providing at least one substrate element comprising at least one first heterogeneous material; and
at least partially locating at least one region comprising at least one further heterogeneous material in the substrate element;
wherein said at least one further heterogeneous material has at least one more scale of heterogeneity than the at least one first heterogeneous material.

38. The method as claimed in claim 37, further comprising:
locating the at least one region in at least one compartment in the substrate element.

39. The method as claimed in claim 38, further comprising:
enclosing the at least one region in a substantially acoustically permeable membrane, wherein the at least one further heterogeneous material is in granular or powder form.

40. (canceled)

41. (canceled)

42. (canceled)

43. Apparatus for attenuating sound transmission, comprising:
a first wall region having an outwardly facing surface configured to receive incident sound waves;
a further wall region spaced apart from the first wall member to define a cavity between the wall regions; and
at least one region of sorptive material located in the cavity to attenuate sound transmission across the wall regions in respect of the incident sound waves.

44. The apparatus as claimed in claim 43, wherein at least the wall regions and the cavity define a resonant system and at least a first resonant frequency of the resonant system is substantially decreased responsive to the at least one region of sorptive material located in the cavity.

45. (canceled)

46. The apparatus as claimed in claim 44, wherein the sound transmission loss across the wall regions is substantially increased in respect of incident sound wave frequencies at and around the decreased resonant frequency.

47. (canceled)

48. (canceled)

49. (canceled)

50. (canceled)

51. The apparatus as claimed in claim 43, wherein the at least one region of sorptive material comprises a monolithic element of adsorptive material.

52. The apparatus as claimed in claim 43, wherein the at least one region of sorptive material is at least partially located in a substantially porous substrate element.

53. The apparatus as claimed in claim 52, wherein the substrate element comprises a 2-scale fibrous or cellular material.

54. (canceled)

55. (canceled)

56. (canceled)

57. (canceled)

58. (canceled)

59. (canceled)

60. (canceled)

61. (canceled)

62. (canceled)

63. (canceled)

64. (canceled)

65. (canceled)

66. (canceled)

67. (canceled)

68. (canceled)

69. A method of attenuating sound transmission, comprising:
locating at least one region of sorptive material in a cavity defined between a first wall region and a further wall region to attenuate sound transmission across the wall regions in respect of sound waves incident on an outwardly facing surface of the first wall region.

70. The method as claimed in claim 69, further comprising decreasing at least a first resonant frequency of a resonant system comprising at least the wall regions and the cavity responsive to locating the at least one region of sorptive material in the cavity.

71. (canceled)

72. (canceled)

73. (canceled)

74. (canceled)
